(19) United States
(12) Patent Application Publication
(10) Pub. No.: US 2025/0285423 A1
(43) Pub. Date: Sep. 11, 2025

(54) METHOD AND APPRATUS FOR PREDICTING ROAD TRAFFIC CARBON EMISSION BASED ON PANORAMIC IMAGE, DEVICE AND MEDIUM

(71) Applicant: AEROSPACE INFORMATION RESEARCH INSTITUTE, CHINESE ACADEMY OF SCIENCES, Beijing (CN)

(72) Inventors: Yonglin ZHANG, Beijing (CN); Li WANG, Beijing (CN); Shiguang XU, Beijing (CN); Ke WANG, Beijing (CN); Wanjuan SONG, Beijing (CN); Ni HUANG, Beijing (CN)

(73) Assignee: AEROSPACE INFORMATION RESEARCH INSTITUTE, CHINESE ACADEMY OF SCIENCES, Beijing (CN)

(21) Appl. No.: 19/069,998

(22) Filed: Mar. 4, 2025

(30) Foreign Application Priority Data
Mar. 7, 2024 (CN) 202410263663.6

(51) Int. Cl. G06V 10/80; G06T 3/16; G06T 7/246; G06V 10/77

(52) U.S. Cl. CPC G06V 10/806; G06T 3/16; G06T 7/248; G06V 10/7715; G06T 2207/20081; G06T 2207/30184; G06T 2207/30252

(57) ABSTRACT

A method and an apparatus for predicting a road traffic carbon emission based on panoramic images, a device and a medium are provided, relating to the technical field of data prediction. In the method, a historical street view image of an observation area is acquired from the Internet, feature analysis is performed on the historical street view image to obtain a historical feature vector, and a road traffic carbon emission predicted value is obtained based on the historical feature vector and a carbon emission prediction model. With the method or the apparatus, auxiliary explanations for carbon emission sources in cities can be provided based on features of street views.

### CROSS-REFERENCE TO RELATED APPLICATION

The present application claims the priority to Chinese Patent Application No. 202410263663.6, filed on Mar. 7, 2024 with the Chinese Patent Office, which is incorporated herein by reference in its entirety.

### FIELD

The present disclosure relates to the technical field of data prediction, and in particular to and an apparatus for predicting a road traffic carbon emission based on panoramic a method images, a device and a medium.

### BACKGROUND

With the development of global urbanization, urban traffic has become a main factor to promoting the growth of carbon emission. Therefore, quantitative observation of road traffic carbon emission is important for maintaining the sustainable development of traffic. At present, according to the conventional quantitative observation technology of road traffic carbon emission, a statistical method is performed based on vehicle mileage and emission factors. However, the calculation results are rough and uncertain in practical application, resulting in a great difference from the actual carbon emission on sites. In addition, changes of traffic carbon emissions inside the road cannot be observed.

In recent years, the international community and ecological environment departments have paid attention to refined distribution patterns of carbon emissions, especially in residential communities, high energy-consuming enterprises and traffic networks. To study hotspots of carbon emissions within cities, it is required to improve the spatial resolution of carbon emission calculation. According to the conventional observation technology, the accuracy of calculation results is low and cannot meet the requirements of studying the distribution patterns of carbon emissions.

### SUMMARY

According to the present disclosure, a method and an apparatus for predicting a road traffic carbon emission based on panoramic images, a device and a medium are provided. A training data set for a carbon emission prediction model is constructed based on actually measured panoramic images of street views and carbon emission concentrations, providing large-scale refined predictions and analysis of distribution patterns of carbon emissions.

In a first aspect, a method for predicting a road traffic carbon emission based on panoramic images is provided according to the present disclosure. The method includes:
acquiring a historical street view image of an observation region from the Internet;
performing feature analysis on the historical street view image to obtain a historical feature vector; and
obtaining a road traffic carbon emission predicted value based on the historical feature vector and a carbon emission prediction model, where the carbon emission prediction model is an ensemble learning model obtained through training, and training samples for the carbon emission prediction model includes multiple collected street view images and multiple corresponding road traffic carbon emission concentration data.

In an embodiment, the method further includes:
performing geographic mapping on the road traffic carbon emission predicted value based on coordinate data of the historical street view image to make coordinate data of the road traffic carbon emission predicted value to be consistent with the coordinate data of the historical street view image;
performing spatial aggregating on the road traffic carbon emission predicted value to obtain a road traffic carbon emission mixed concentration value; and
performing hierarchical visualization processing on the road traffic carbon emission mixed concentration value to obtain a road traffic carbon emission prediction map.

In an embodiment, the carbon emission prediction model is trained by:
obtaining the multiple collected street view images and the multiple corresponding road traffic carbon emission concentration data from a spatiotemporal database, where the spatiotemporal database, with a timestamp string as a primary key, stores the multiple collected street view images and the multiple corresponding road traffic carbon emission concentration data;
performing analysis on the multiple collected street view images to obtain multiple collected feature vectors, where each of the collected feature vectors includes a pixel semantic classification vector and a target recognition statistical vector;
performing fusing and concatenating on the pixel semantic classification vector and the target recognition statistical vector corresponding to each of the collected feature vectors, and obtaining multiple fused feature vectors; and
training an initial model with the multiple fused feature vectors and the multiple collected road traffic carbon emission concentration data as the training samples to obtain the carbon emission prediction model.

In an embodiment, the spatiotemporal database is obtained by:
obtaining observation data, and performing data cleaning on collected road traffic carbon emission concentration data in the observation data, where the observation data includes collected street view images and collected road traffic carbon emission concentration data of the observation region;
performing time-scale aggregation with a predetermined time interval to remove observation data staying at a same coordinate for more than a predetermined staying time period and observation data repeatedly observed;
performing spatial registering on coordinates in filtered observation data based on a road network vector layer; and
storing the filtered observation data in a structured database with the timestamp string as the unique primary key to obtain the spatiotemporal database.

In an embodiment, the observation data is obtained by:
acquiring vector road data of the observation region from the Internet;
obtaining a navigation path based on the vector road data;
monitoring road traffic carbon emission concentrations and capturing street view images based on the navigation path; and
exporting the monitored road traffic carbon emission concentrations to obtain the collected road traffic carbon emission concentration data, and storing the captured street view images in an image format to obtain the collected street view images.

In an embodiment, the method further includes:
calculating, by using a SHAP analysis algorithm, a feature contribution degree of each of environment variables in an environment variable set for the carbon emission prediction model to obtain a variable feature data set, where the environment variable set includes the environment variables affecting the road traffic carbon emission;
sorting variable feature data sets based on feature importance to obtain a predetermined number of sorted variable feature data sets; and
performing visualization processing on environment variables corresponding to the sorted variable feature data sets to obtain a feature importance map.

In a second aspect, an apparatus for predicting a road traffic carbon emission based on panoramic images is provided according to the present disclosure. The apparatus includes an acquiring unit, an analysis unit, and an obtaining unit. The acquiring unit is configured to acquire a historical street view image of an observation region from the Internet. The analysis unit is configured to perform feature analysis on the historical street view image to obtain a historical feature vector. The obtaining unit is configured to obtain a road traffic carbon emission predicted value based on the historical feature vector and a carbon emission prediction model, where the carbon emission prediction model is an ensemble learning model obtained through training, and training samples for the carbon emission prediction model include multiple collected street view images and collected road traffic carbon emission concentration data corresponding to the multiple collected street view images.

In an embodiment, the apparatus further includes a geographic mapping unit, a spatial aggregation unit, and a visualization unit. The geographic mapping unit is configured to perform geographic mapping on the road traffic carbon emission predicted value based on coordinate data of the historical street view image to make coordinate data of the road traffic carbon emission predicted value to be consistent with the coordinate data of the historical street view image. The spatial aggregation unit is configured to perform spatial aggregating on the road traffic carbon emission predicted value to obtain a road traffic carbon emission mixed concentration value. The visualization unit is configured to perform hierarchical visualization processing on the road traffic carbon emission mixed concentration value to obtain a road traffic carbon emission prediction map.

In an embodiment, the apparatus further includes a fusing unit and a training unit. In training the carbon emission prediction model, the acquiring unit is further configured to obtain the multiple collected street view images and the multiple corresponding road traffic carbon emission concentration data from a spatiotemporal database, where the spatiotemporal database, with a timestamp string as a primary key, stores the multiple collected street view images and the multiple corresponding road traffic carbon emission concentration data; the analysis unit is further configured to perform analysis on the multiple collected street view images to obtain multiple collected feature vectors, where each of the collected feature vectors includes a pixel semantic classification vector and a target recognition statistical vector; the fusing unit is configured to perform fusing and concatenating on the pixel semantic classification vector and the target recognition statistical vector corresponding to each of the collected feature vectors, and obtain multiple fused feature vectors; and the training unit is configured to train an initial model with the multiple fused feature vectors and the multiple collected road traffic carbon emission concentration data as the training samples to obtain the carbon emission prediction model.

In an embodiment, the apparatus further includes a removing unit, a spatial registration unit, and a storage unit. In obtaining the spatiotemporal database, the obtaining unit is further configured to obtain observation data and perform data cleaning on collected road traffic carbon emission concentration data in the observation data, where the observation data includes collected street view images and collected road traffic carbon emission concentration data of the observation region; the removing unit is configured to perform time-scale aggregation with a predetermined time interval to remove observation data staying at a same coordinate for more than a predetermined staying time period and observation data repeatedly observed; the spatial registration unit is configured to perform spatial registering on coordinates in filtered observation data based on a road network vector layer; and the storage unit is configured to store the filtered observation data in a structured database with the timestamp string as the unique primary key to obtain the spatiotemporal database.

In an embodiment, the apparatus further includes a processing unit. In obtaining the observation data, the acquiring unit is further configured to acquire vector road data of the observation area from the Internet; the obtaining unit is further configured to obtain a navigation path based on the vector road data; the processing unit is configured to monitor road traffic carbon emission concentrations and capturing street view images based on the navigation path; and the obtaining unit is further configured to export the monitored road traffic carbon emission concentrations to obtain the collected road traffic carbon emission concentration data, and store the captured street view images in an image format to obtain the collected street view images.

In an embodiment, the apparatus further includes an analyzing unit, a sorting unit, and a visualization unit. The analyzing unit is configured to calculate, by using a SHAP analysis algorithm, a feature contribution degree of each of environment variables in an environment variable set for the carbon emission prediction model to obtain a variable feature data set, where the environment variable set includes the environment variables affecting the road traffic carbon emission. The sorting unit is configured to sort the environment variables in the variable feature data set based on feature importance to obtain a sorted variable feature data set with a predetermined number. The visualization unit is configured to perform visualization processing on environment variable corresponding to the sorted variable feature data set to obtain a feature importance map.

In a third aspect, an electronic device is provided according to the present disclosure. The electronic device includes a memory and a processor. The memory stores a computer program. The processor is configured to execute the computer program to perform the method provided in the first aspect.

In a fourth aspect, a computer-readable storage medium is further provided according to the present disclosure. The computer-readable storage medium stores a computer program. The computer program is executed to perform the method provided in the first aspect.

It can be seen that the present disclosure has the following beneficial effects.

According to the present disclosure, a method for predicting a road traffic carbon emission based on panoramic images is provided. A historical street view image of an observation area is firstly acquired from the Internet, then feature analysis is performed on the historical street view image to obtain a historical feature vector, and then a road traffic carbon emission predicted value is obtained based on the historical feature vector and a carbon emission prediction model. In the above process, street view panoramic images and road traffic carbon emissions are collaboratively observed and trained, and a large-scale spatial deduction is performed with the panoramic images as a medium, thereby performing a refined carbon emission simulation. With the method according to the present disclosure, the resolution of the constructed carbon emission prediction model can be improved, and the interactive relationship between street environments and carbon emission intensities can be well understood, thereby realizing carbon emission intelligent observation and low-carbon sustainable traffic management.

### BRIEF DESCRIPTION OF THE DRAWINGS

In order to clearly describe the technical solutions in the embodiments of the present disclosure, drawings to be used in the description of the embodiments of the present disclosure are briefly described hereinafter. It is apparent that the drawings described below are merely used for describing the embodiments of the present disclosure, and those skilled in the art may obtain other drawings according to the provided drawings without any creative effort.

FIG. 1 is a flowchart of a method for predicting a road traffic carbon emission based on panoramic images according to an embodiment of the present disclosure;

FIG. 2 is a flowchart of a method for predicting a road traffic carbon emission based on panoramic images according to an embodiment of the present disclosure;

FIG. 3 is a flowchart of a method for predicting a road traffic carbon emission based on panoramic images according to an embodiment of the present disclosure;

FIG. 4 is a schematic diagram showing collaboratively collecting a street view image and a road traffic carbon emission on site according to an embodiment of the present disclosure;

FIG. 5 is a schematic diagram showing a structure of an encoder in a carbon emission prediction model according to an embodiment of the present disclosure;

FIG. 6 is a schematic diagram showing a fitting and diagnosis result of a carbon emission prediction model according to an embodiment of the present disclosure;

FIG. 7 is a schematic diagram showing intensity levels of road traffic carbon emissions according to an embodiment of the present disclosure;

FIG. 8 is a schematic diagram showing a ranking of feature importance according to an embodiment of the present disclosure;

FIG. 9 is a schematic structural diagram of an apparatus for predicting a road traffic carbon emission based on panoramic images according to an embodiment of the present disclosure; and

FIG. 10 is a schematic structural diagram of an electronic device according to an embodiment of the present disclosure.

### DETAILED DESCRIPTION

The technical solutions according to the embodiments of the present disclosure are to be described clearly and completely below in conjunction with the drawings in the embodiments of the present disclosure. It is apparent that the described embodiments are only some of the embodiments according to the present disclosure, rather than all the embodiments. Any other embodiments obtained by those skilled in the art based on the embodiments of the present disclosure without any creative work fall within the protection scope of the present disclosure.

It should be noted that the user information (including but not limited to user device information and user personal information) and data (including but not limited to to-be-analyzed data, stored data, and displayed data) involved in the present disclosure are all authorized by the user or fully authorized by all related parties. In addition, the collection, usage and processing of the relevant data comply with relevant laws, regulations, and standards of relevant countries and regions.

The technical terms involved in embodiments of the present disclosure are explained as follows.
(1) For Transformer feature extractor, Transformer is a deep neural network based on a self-attention mechanism and is initially applied in the field of natural language processing. Inspired by Transformer's powerful representation capability, researchers proposed to extend Transformer to computer vision tasks, that is, a pure Transformer called Vision Tran (Vision Transformer, ViT). When directly applied to image block sequences, the Vision Transformer performs well in visual classification tasks. Compared to other types of networks (such as a convolutional network and a recurrent network), models based on Transformer have competitive and even better performance on various visual benchmarks.
(2) TreeSHAP model is a Python library for interpreting machine learning model predictions. The model predictions may be explained by calculating contributions of all features to the predicted output of each individual, and the contributions may be visualized.
(3) For LightGBM model, a histogram algorithm is adopted in the histogram algorithm LightGBM, occupying less memory and having lower complexity of data segmentation. By adopting an efficient feature splitting strategy and a parallel computation mode, the speed of training the model can be significantly improved.

At present, with the development of global urbanization, urban traffic has become a main factor promoting the growth of carbon emission. Studies show that the transportation accounts for about 23% of total urban carbon emissions in cities, and the carbon emission proportion is still increasing. Additional carbon emissions are generated due to the increase in the number of private cars, unreasonable urban forms, the increase in commuting distances between work and residence, and the excessive dependence on fossil fuels. In recent years, the international community and ecological environment departments have paid attention to refine distribution patterns of carbon emissions, especially in residential communities, high energy-consuming enterprises and traffic networks. It is required to further improve the spatial resolution of carbon emission calculation to identify hotspots of carbon emissions within cities. However, no intelligent simulation method for road traffic carbon emissions based on actual measurements is provided. According to the conventional quantitative observation technology of road traffic carbon emission, a statistical method is performed based on vehicle mileage and emission factors. However, the calculation results are rough and uncertain in practical application, resulting in a great difference from the actual carbon emission on sites. In addition, changes of traffic carbon emissions inside the road cannot be observed.

Due to the complex correlation between urban built environments and residents' travel behaviors, the road network density restricts residents' travel choices and accessibility, thereby affecting the spatial aggregation features of road traffic carbon emissions. Therefore, it is required to comprehensively quantify the spatial features of urban streets to reveal the spatial layout of road traffic carbon emissions and environmental influence factors. Street view panoramic images have made significant progress in many fields such as public health, social economy and air quality monitoring, may comprehensively perceive the physical space of urban roads, and reflect the details of road environments, land use attributes or land use status. Specifically, a panoramic image contains environmental information such as the number of lanes, pedestrian density, and building types, which are closely related to transportation and residents' behaviors, thereby providing a potential possibility for predicting spatial patterns of road traffic carbon emissions.

Therefore, the features may be quantitatively extracted and analyzed based on content analysis of panoramic images, and then a spatial correlation model between the features and carbon emissions may be established. At present, street view images have covered most of road networks of most cities, and depict the landscape configuration and land usages on both sides of the streets, facilitating establishing a carbon emission prediction model and improving the resolution of the carbon emission prediction model, and facilitating understanding the interactive relationship between street environments and carbon emission intensities.

In the embodiments of the present disclosure, a training data set for a carbon emission prediction model is constructed based on a really measured street view panoramic images and carbon emission concentrations, providing a large-scale refined predictions and analysis of carbon emission distribution patterns. In implementations, the method, for example, may include: acquiring a historical street view image of an observation region from the Internet; performing feature analysis on the historical street view image to obtain a historical feature vector; and obtaining a road traffic carbon emission predicted value based on the historical feature vector and a carbon emission prediction model. The carbon emission prediction model is an ensemble learning model obtained through training, and training samples for the carbon emission prediction model includes multiple collected street view images and multiple corresponding road traffic carbon emission concentration data.

It can be seen that with the method according to the embodiments of the present disclosure, more information, which reflecting the actual conditions of roads during driving, may be obtained through the street view panoramic images. Therefore, the resolution of the constructed carbon emission prediction model can be improved, and the interactive relationship between street environments and carbon emission intensities can be well understood, thereby providing a large-scale refined predictions and analysis of carbon emission distribution patterns.

To facilitate understanding of the implementations of the method for predicting a road traffic carbon emission based on panoramic images according to the embodiments of the present disclosure, illustrations are provided below in conjunction with the accompanying drawings.

It should be noted that the object performing the method for a predicting road traffic carbon emission based on panoramic images may be the apparatus for predicting a road traffic carbon emission based on panoramic images according to the embodiments of the present disclosure. The apparatus for predicting a road traffic carbon emission based on panoramic images may be implemented by an electronic device or a function module of an electronic device. The electronic device in the embodiments of the present disclosure may be any device, such as an Internet of Things (IoT) device, capable of performing the method for predicting a road traffic carbon emission based on panoramic images according to the embodiments of the present disclosure.

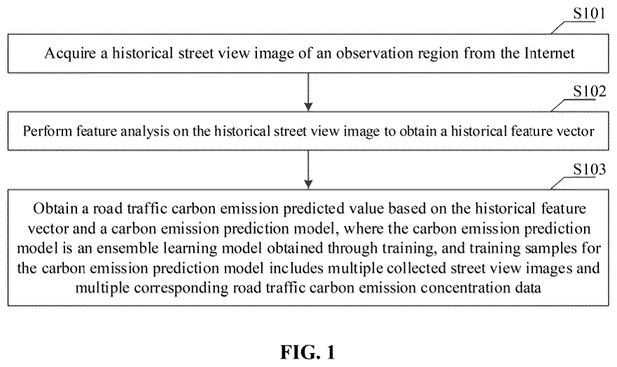

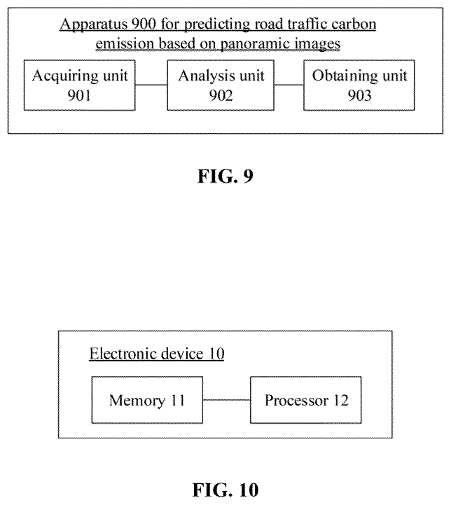

FIG. 1 is a flowchart of a method for predicting a road traffic carbon emission based on panoramic images according to an embodiment of the present disclosure. The method may be applied to an apparatus for predicting a road traffic carbon emission based on panoramic images. For example, the apparatus for predicting a road traffic carbon emission based on panoramic images may be an apparatus 900 for predicting a road traffic carbon emission based on panoramic images as shown in FIG. 9, or may be a function module integrated in an electronic device 10 as shown in FIG. 10.

As shown in FIG. 1, the method includes the following steps S101 to S103.

In S101, a historical street view image of an observation region is acquired from the Internet.

To obtain a road traffic carbon emission predicted value, a historical street view image of an observation region is acquired from the Internet, then feature analysis is performed on the historical street view image to obtain a historical feature vector, and then the road traffic carbon emission predicted value is obtained based on the historical feature vector and a carbon emission prediction model. Therefore, in the embodiment of the present disclosure, the historical street view image of the observation region is acquired from the Internet in step S101, which provides a precondition for obtaining the historical feature vector.

As an example, step S101 may include: acquiring the historical street view image of the observation region through an online map platform on the Internet, and storing the historical street view image in a binary format in a local panoramic image database. In performing prediction, the street view image may be directly acquired form the local panoramic image database. The fields in the local panoramic image database may include: an image ID, shooting time, an orientation, latitude and longitude coordinates, image data, and the like.

In S102, feature analysis is performed on the historical street view image to obtain a historical feature vector.

As an example, step S102 may include: performing feature extraction and analysis by using a Transformer feature extractor to obtain a feature matrix as the historical feature vector.

In S103, a road traffic carbon emission predicted value is obtained based on the historical feature vector and a carbon emission prediction model. The carbon emission prediction model is an ensemble learning model obtained through training, and training samples for the carbon emission prediction model include multiple collected street view images and multiple corresponding road traffic carbon emission concentration data.

As an example, step S103 may include: inputting the historical feature vector to the carbon emission prediction model, and performing automatic deduce based on features of each of rows of the historical feature vector to obtain a carbon emission concentration simulation result corresponding to the historical street view image as the road traffic carbon emission predicted value. In the above process, algorithms, such as a deep learning algorithm, may be used to actively learn features and select useful information from the features, avoiding bias caused by manually selecting variables.

The carbon emission prediction model may be trained by: obtaining the multiple collected street view images and the multiple corresponding road traffic carbon emission concentration data from a spatiotemporal database, where the spatiotemporal database, with a timestamp string as a primary key, stores the multiple collected street view images and the multiple corresponding road traffic carbon emission concentration data; performing analysis on the multiple collected street view images to obtain multiple collected feature vectors, where each of the collected feature vectors includes a pixel semantic classification vector and a target recognition statistical vector; performing fusing and concatenating on the pixel semantic classification vector and the target recognition statistical vector corresponding to each of the collected feature vectors, and obtaining multiple fused feature vectors; and training an initial model with the multiple fused feature vectors and the multiple collected road traffic carbon emission concentration data as the training samples to obtain the carbon emission prediction model.

Due to serious bias caused by collinearity of some features, such as uncommon scenes in urban streets, indoor objects and misclassified pixels, it is required to remove irrelevant features based on physical prior knowledge. Fusing and concatenating is performed on the pixel semantic classification vector and the target recognition statistical vector corresponding to each of the collected feature vectors as shown in the following equation (1):

$$Verctor = [ {Class}_{1} , {Class}_{2} , … , {Class}_{n} ] ⊕ [ {Object}_{1} , {Object}_{2} , … , {Object}_{m} ] \qquad ( 1 )$$

In equation (1), Vector represents a filtered and fused feature vector, Class, represents a proportion of an n-th type of pixels obtained by using a panoramic segmentation technology to an entire image, Objectₘ represents the number of an m-th type of objects obtained by using a panoramic segmentation technology, and ⊕ represents a feature concatenating operation.

In addition, there is a mapping relationship between the multiple fused feature vectors and the multiple collected road traffic carbon emission concentration data in the training samples. Using a deep convolutional network model for semantic segmentation and target detection tasks in a Transformer framework, as a complex nonlinear function, a regression mapping between the fused feature vectors and the collected road traffic carbon emission concentration data is established as shown in the following equation (2):

$${F}_{c o 2}^{n u m} = f ( {Vector}^{n u m} ) \qquad ( 2 )$$

In equation (2), F_{co2} represents a carbon emission concentration, measured in ppm; num represents the total number of training samples in the training process, and represents a dimensionality of inputted features of the local panoramic database in the prediction simulation process; and f represents the deep convolutional network model for semantic segmentation and target detection tasks in the Transformer framework.

The gradient tree boosting model has a strong ability to identify nonlinear relations, and performs well in predicting complex features, (especially high-dimension image features), generalization ability, and nonlinear interpretation. Due to the complex causes of road traffic carbon emission and various environmental impact factors, the gradient tree regression model is required for nonlinear interpretation. The LightGBM ensemble learner has a fastest training speed and performs well. Therefore, LightGBM is used as the regression model in the embodiments of the present disclosure, and a TreeSHAP gradient tree interpretable module is used as the carbon emission prediction model.

For example, the LightGBM may be determined as the regression model by: splitting the training set and the validation set in a 9:1 ratio, and then performing Bayesian search to perform 30 rounds of hyperparameter optimization on multiple ensemble learners. The multiple ensemble learners may include: LightGBM, Random Forest (RF), Gradient Boosting Machine (GBM), and Ultimate Gradient Boosting Machine (XGBoost). Model performance diagnosis is performed with indicators of a goodness of fit R², a mean absolute error MAE and a mean percentage error MAPE after 5-fold cross-validation as model diagnostic parameters, as shown in the following equations (3), (4) and (5):

$${R}^{2} = 1 - \frac{{\sum }_{i}^{n} {( {\hat{y}}_{i} - {y}_{i} )}^{2}}{{\sum }_{i}^{n} {( {\overline{y}}_{i} - {y}_{i} )}^{2}} \qquad ( 3 )$$

$$M A E = \frac{1}{n} {\sum }_{i = 1}^{n} \vert {\hat{y}}_{i} - {y}_{i} \vert \qquad ( 4 )$$

$$MAPE = \frac{100 \%}{n} {\sum }_{i = 1}^{n} \vert \frac{{\hat{y}}_{i} - {y}_{i}}{{y}_{i}} \vert \qquad ( 5 )$$

In the above equations, yᵢ represents an i-th real value in the validation set, ŷᵢ represents an i-th predicted value, and y̅ represents an average value of i real values in the validation set.

It should be noted that after the calculation and comparison based on the goodness of fit, the mean absolute error and the mean percentage error, it may be determined that that the LightGBM model has a best performance and may be used as the regression model in the embodiments of the present disclosure. In addition, the optimal hyperparameter configuration for machine learning and the trained model are physically stored in a binary file format, ensuring the reusability, reproducibility, and scalability of the model. In addition, the model calculation may be performed through multithread computation by using, for example, Intel Xeon 4110 CPU*2.

An hour attribute may be substituted to the trained carbon emission prediction model to calculate a road traffic carbon emission simulation result corresponding to a hour, thereby viewing change at different times (hourly mean changes during the day) and establishing a dynamic monitoring model for carbon emission changes.

In an embodiment of the present disclosure, the spatiotemporal database may be constructed by: obtaining observation data, and performing data cleaning on collected road traffic carbon emission concentration data in the observation data, where the observation data includes collected street view images and collected road traffic carbon emission concentration data of the observation region; performing time-scale aggregation with a predetermined time interval to remove observation data staying at a same coordinate for more than a predetermined staying time period and observation data repeatedly observed; performing spatial registering on coordinates in filtered observation data based on a road network vector layer; and storing the filtered observation data in a structured database with the timestamp string as the unique primary key to obtain the spatiotemporal database. The observation data repeatedly observed is removed by: determining whether the observation data is repeatedly observed based on coordinates of the observation data and coordinates of a navigation path; determining that the observation data is repeatedly observed in a case that timestamps are different and positions are similar; and deleting previous observation data and saving a latest observation record.

It should be noted that the observation data is obtained by: acquiring vector road data of the observation region from the Internet; obtaining a navigation path based on the vector road data; monitoring road traffic carbon emission concentrations and capturing street view images based on the navigation path; and exporting the monitored road traffic carbon emission concentrations to obtain the collected road traffic carbon emission concentration data, and storing the captured street view images in an image format to obtain the collected street view images. In the above process, the computer vision technology may be used to automatically analyze image content to continuously obtain data and significantly reduce labor costs. Furthermore, panoramic street images are collected to reflect the actual road conditions during driving.

In an embodiment of the present disclosure, after obtaining the road traffic carbon emission predicted value, visualization processing may be further performed by: performing geographic mapping on the road traffic carbon emission predicted value based on coordinate data of the historical street view image to make coordinate data of the road traffic carbon emission predicted value to be consistent with the coordinate data of the historical street view image; performing spatial aggregating on the road traffic carbon emission predicted value to obtain a road traffic carbon emission mixed concentration value; and performing hierarchical visualization processing on the road traffic carbon emission mixed concentration value to obtain a road traffic carbon emission prediction map. In the above process, the hierarchical visualization processing may be performed based on the road traffic carbon emission predicted value, and places where the carbon emission concentration accumulation phenomenon is most likely to occur within urban traffic may be intuitively determined through the road traffic carbon emission prediction map. For these places, low-carbon management and intervention should be performed according to local conditions, providing low-carbon decision-making guidance for ecological planning departments.

The effects of road physical environments and mobile carbon sources on road traffic carbon emissions may be explained by using a TreeSHAP model. Therefore, in an embodiment of the present disclosure, a feature contribution degree of each of environment variables in an environment variable set for the carbon emission prediction model may be calculated by using a SHAP analysis algorithm to obtain a variable feature data set. The environment variable set includes the environment variables affecting the road traffic carbon emission, such as buildings, roads, altitudes, and other environment factors. Variable feature data sets are sorted based on feature importance to obtain a predetermined number of sorted variable feature data sets. For example, first ten variable feature data sets are obtained as the sorted variable feature data sets. Visualization processing is performed on environment variables corresponding to the sorted variable feature data sets to obtain a feature importance map. In the above process, the key environment influence factors for the road traffic carbon emission are analyzed based on a Shapley value, having an important practical value for management and control of the road traffic carbon emission and facilitating intelligent carbon emission observation and low-carbon sustainable traffic management.

The SHAP analysis algorithm is a scientific interpretation based on the evolution of the concept of Shapley value in Shapley value game theory. The Shapley value may be calculated by using the following equation (6):

$$Shapely ( {X}_{j} ) = {\sum }_{S ⊆ N ∖ \{ j \}} \frac{k ! ( p - k - 1 ) !}{p !} ( f ( S ⋃ \{ j \} ) - f ( S ) ) \qquad ( 6 )$$

In equation (6), P represents the total number of features, k represents a k-th feature, N\{j} represents all other feature sets except for a feature X, S represents a feature set in N\{j}, f(S) represents model prediction values of features in S, and f(S∪{j}) is model prediction values of features in S and feature X.

A local additive feature is generated based on Shapley values by using the following equation (7):

$${\hat{y}}_{i} = {Shapely}_{0} + Shapely ( {X}_{1 i} ) + … + Shapely ( {X}_{pi} ) \qquad ( 7 )$$

In equation (7), ŷᵢ represents a model prediction value of an observed value i, Shapely₀ represents an average prediction value of all observed values, and Shapely(Xⱼᵢ) represents a marginal contribution (prediction value minus the average prediction value) of a j-th feature of the observed value i.

Due to the additivity of Shapley values, the sum of absolute values of the Shapley values reflects the impact strength of features on the model prediction, that is, the Shapley value of the feature j is equal to the sum of Shapely(Xⱼᵢ) of all samples. Therefore, the Shapley values may be used for feature importance comparison. Based on the above theory, the Shapley mean value is used as a measurement index in the feature importance map to identify the influence factors of road traffic carbon emission.

It can be seen that in the embodiments of the present disclosure, more information, which reflecting the actual conditions of roads during driving, may be obtained through the street view panoramic images. Therefore, the resolution of the constructed carbon emission prediction model can be improved, and the interactive relationship between street environments and carbon emission intensities can be well understood, thereby providing a large-scale refined predictions and analysis of carbon emission distribution patterns. Thus, the embodiments of the present disclosure have an important practical value for management and control of the road traffic carbon emission and are help for intelligent carbon emission observation and low-carbon sustainable traffic management.

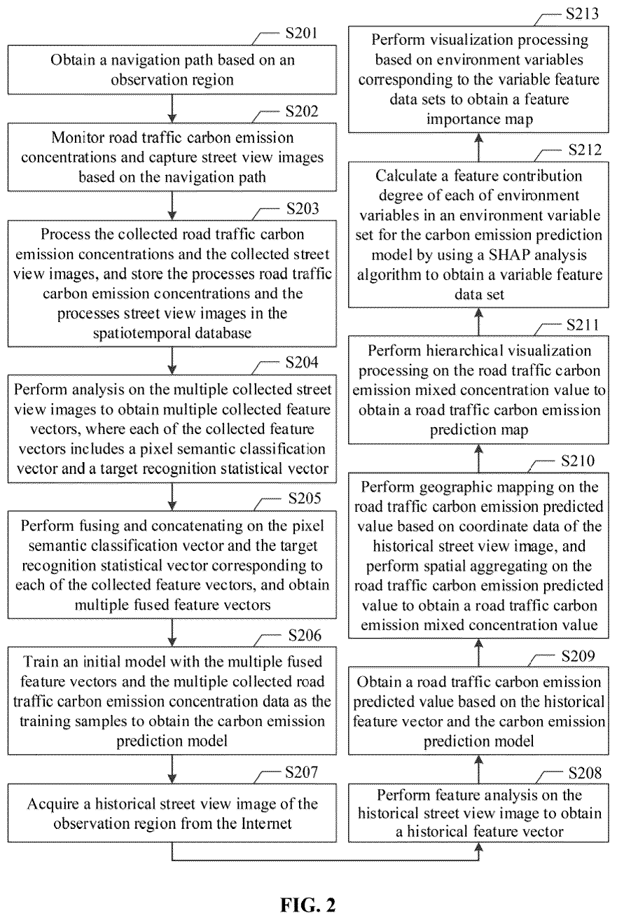

To make the method according to the embodiments of the present disclosure clear and comprehensible, a specific embodiment of the method is illustrated below in conjunction with FIG. 2.

As shown in FIG. 2, the embodiment may include the following steps S201 to S213.

In S201, a navigation path is obtained based on the observation region.

In the embodiment of the present disclosure, actual measurements are performed by taking Shenzhen as an example. A driving path and a boundary of Shenzhen are planned based on an internet open map, that is, vector road data is obtained. Then, a vector road shapefile layer is exported by using a GIS software based on the vector road data. Then, the vector road shapefile layer is stored in a navigation software in a mobile phone, and path navigation planning and storage are performed by using a GeoTracker open-source software to obtain the navigation path.

In S202, based on the navigation path, road traffic carbon emission concentrations are monitored and street view images are captured.

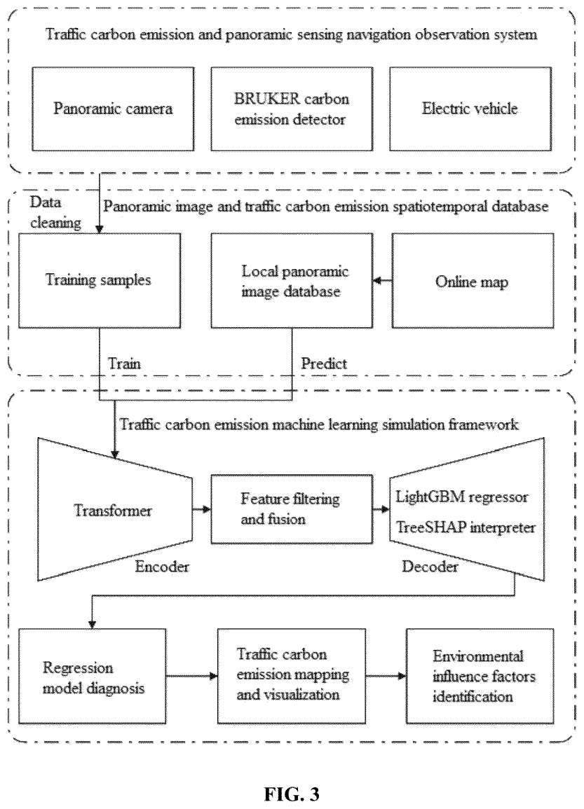

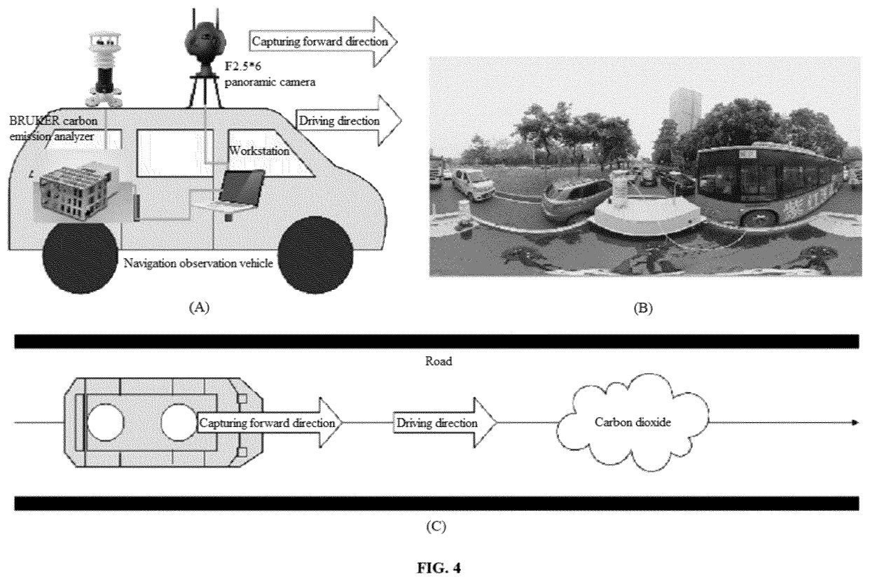

In the embodiment of the present disclosure, to monitor the road traffic carbon emission concentrations and capture the street view images, a panoramic camera and a road traffic carbon emission navigation observation system are constructed. As shown in FIG. 3, a vehicle, a panoramic camera and a BRUKER carbon emission detector are adopted. FIG. 4 shows the specific configuration. The vehicle is arranged with a BRUKER-MG greenhouse gas monitoring device (including a gas detector arranged on a roof of the vehicle and a carbon emission collector arranged in the vehicle), and a F2.5*6 fisheye panoramic camera. The device for collecting the road traffic carbon emission concentrations may include the BRUKER carbon emission detector, and may further include other medium-precision/high-precision greenhouse gas monitoring devices, such as Picarro G series devices or domestic greenhouse gas monitoring sensors.

The BRUKER detector is calibrated using a standard gas cylinder for environment monitoring before the navigation observation to control the monitoring error of the BRUKER detector for carbon emission concentrations to be below 150 ppb. The panoramic camera is mounted on an adjustable tripod with a vacuum suction cup base through a digital camera gimbal. The camera is fixed at a height of 2.20 m from a horizontal ground. In installing the panoramic camera, gesture control is performed on the panoramic camera by using a Garmin laser rangefinder to ensure that a central camera of the panoramic camera is aligned with a forward direction of the vehicle, and the panoramic camera is manually fixed by a screw knob. The above two sets of devices are activated simultaneously before performing the navigation observation mission, and the two sets of devices perform data sampling respectively at frequencies of 0.5 Hz and 0.25 Hz. The BRUKER-MG device is connected to a mobile workstation through an RJ45 network cable. Data is transmitted and stored by a built-in control software of BRUKER, and is exported in an Excel spreadsheet format. The panoramic camera is connected to the workstation through an RJ45 network cable for obtaining panoramic images. The panoramic images are saved in .jpg format with an image resolution of 2K (2560*1440). EXIF metadata of the images includes camera imaging parameters, shooting time, and longitude and latitude coordinates.

In the embodiment of the present disclosure, a GAC's Aion electric vehicle (which may be replaced with other electric vehicles) is used as a base for sensors. The sensors are connected to a power supply system of the electric vehicle, and have been tested to support continuous observation for 20 hours a day. An on-site navigation observation may be performed from 8:00 to 18:00 on weekdays. The collected road traffic carbon emission concentration data may be exported in an Excel spreadsheet format, and the collected street view images may be backed up and stored in a picture format in the workstation. The naming rule for street view images may be: [City]_[Time]_[Coordinates].jpg.

It should be noted that the panoramic camera and road traffic carbon emission navigation observation system in the embodiment of the present disclosure may be used to perform observation of road traffic carbon emission concentrations in domestic or foreign urban roads, and is not limited to Shenzhen.

In S203, the collected road traffic carbon emission concentrations and the collected street view images are processed and stored in the spatiotemporal database.

As shown in FIG. 4, the collected road traffic carbon emission concentrations and the collected street view images are processed (such as performing data cleaning on the collected road traffic carbon emission concentrations and the collected street view images), and then the processed road traffic carbon emission concentrations and street view images are stored in the spatiotemporal database as training samples. The collected road traffic carbon emission concentrations and the collected street view images may be processed by: excluding outliers in the collected road traffic carbon emission concentrations based on a Laida criterion in statistics, where the excluded road traffic carbon emission concentrations are not used in training and subsequent calculation; performing time-scale aggregation at a time interval of 1 s by using Python and GeoPandas to remove records staying at a same geographic coordinate for more than 15 minutes and records repeatedly observed along the navigation path; performing spatial registering by using a spatial registration tool in a QGIS geographical information system based on a AMap's road network vector layer to map coordinates of a small number of sampling points with offset to a nearest neighbor road; and storing the road traffic carbon emission records and panoramic image binary files in a structured database with the timestamp string as the unique main key, where the structured database may be configured with an open-source PostgreSQL v 12.2 database management system.

In the embodiment of the present disclosure, the number of records finally stored in the spatiotemporal database may be 100243, totaling over 100,000 valid records, which are to be used for subsequent model training.

In S204, analysis is performed on the multiple collected street view images to obtain multiple collected feature vectors. Each of the collected feature vectors includes a pixel semantic classification vector and a target recognition statistical vector.

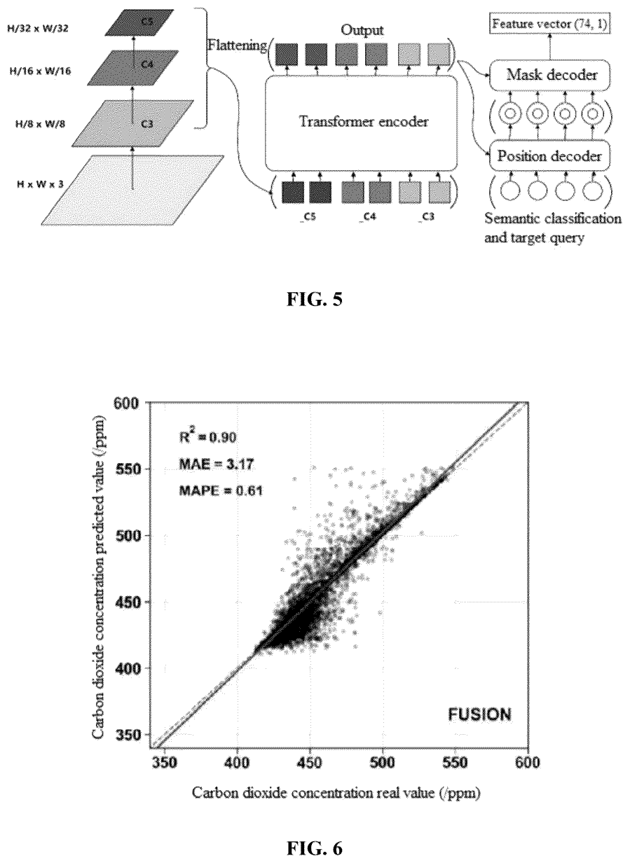

As shown in FIG. 4, the collected street view images in the training samples are inputted to a Transformer panoramic segmentation framework, and the Transformer panoramic segmentation framework performs quantitative analysis on the collected street view images in the training data. That is, each of to-be-processed panoramic images is parsed into a feature vector by performing panoramic segmentation. FIG. 5 shows a network architecture of a Transformer panoramic segmentation framework. The panoramic segmentation is a multi-task framework including semantic segmentation and target recognition. Before performing analysis, pre-training is performed with a Microsoft COCO data set, and training is performed with a single NVIDIA RTX3090 graphics acceleration card. A training time period is set to 1 week. The accuracy of global segmentation and recognition exceeds 80% (measured by a panoptic quality index), achieving a high precision level in the field of panoramic segmentation.

The obtained features after analyzing may be defined as a pixel semantic classification vector and a target recognition statistical vector. The pixel semantic classification vector refers to a ratio of a specific landscape component (such as a tree, grassland, a building and a road) to a pixel area of a panoramic image. The target recognition statistical vector refers to a number statistics of a target object (various vehicles, pedestrians, chimneys, and the like). The obtained features may indicate physical details of vertical building environments on both sides of urban roads and statistical information such as the number of vehicles and pedestrians on the road.

In S205, fusing and concatenating is performed on the pixel semantic classification vector and the target recognition statistical vector corresponding to each of the collected feature vectors, and multiple fused feature vectors are obtained.

As shown in FIG. 4, the pixel semantic classification vector and the target recognition statistical vector are filtered and concatenated to obtain a 74*1 vector, and a feature mapping relationship between the 74*1 dimensional vector and the carbon emission concentrations is established for training, diagnosing and predicting the regression model.

In S206, an initial model is trained with the multiple fused feature vectors and the multiple collected road traffic carbon emission concentration data as the training samples to obtain the carbon emission prediction model.

As shown in FIG. 4, an initial model is trained with the fused feature vectors and the collected road traffic carbon emission concentration data, which have a feature mapping relationship, as the training samples to obtain the carbon emission prediction model. The training process may include: performing fitting training by using a LightGBM regressor based on the above 100000 fused feature vectors and the collected road traffic carbon emission concentration data; optimizing the LightGBM regression model by using an open-source Optuna Bayesian hyperparameter optimizer to obtain an optimal parameter solution set; and storing the obtained optimal machine parameter solution set locally as a binary file (.pkl) for subsequent simulation prediction. In the above process, the regression model diagnosis is performed to obtain the optimal parameter solution set for the LightGBM regression model, as shown in FIG. 4.

FIG. 6 shows a model training and diagnosis result, in which the goodness of fit R2 is 90% and MAE is below 3.2 ppm, indicating that the carbon emission prediction model according to the embodiments of the present disclosure has a good fitting effect on road traffic carbon emission.

In S207, a historical street view image of the observation region is acquired from the Internet.

As shown in FIG. 4, a street view panoramic image is acquired from an online map and is saved in a local panoramic image database. Simulation is performed by using by the carbon emission prediction model, thereby characterizing the spatial difference of carbon emissions in a city. The following operations may be performed. A historical street view panoramic image of Shenzhen is obtained from an online map platform, and is stored in a binary format in the PostgreSQL database. The field includes: an image ID, shooting time, an orientation, latitude and longitude coordinates, image data, and the like, and the data amount is 250000 pieces (250189).

In S208, feature analysis is performed on the historical street view image to obtain a historical feature vector.

Feature analysis is performed on the historical panoramic street view image of Shenzhen by using the Transformer feature extractor, and a 74*250000 feature matrix is stored, that is, the historical feature vector is obtained.

In S209, a road traffic carbon emission predicted value is obtained based on the historical feature vector and the carbon emission prediction model.

The historical feature vector is inputted to the carbon emission prediction model, and automatic deduction is performed based on features in each of rows of the matrix to a carbon emission predicted value corresponding to each of historical panoramic images.

In S210, geographic mapping is performed on the road traffic carbon emission predicted value based on coordinate data of the historical street view image, and spatial aggregating is performed on the road traffic carbon emission predicted value to obtain a road traffic carbon emission mixed concentration value.

Spatial averaging is performed on the road traffic carbon emission predicted value, by using open-source modules Python and Geopandas, to aggregate the road traffic carbon emission predicted value to a 100 m*100 m grid scale (or other spatial scales according to requirements). There are at least 12 sampling point records in a grid. Then, a road traffic carbon emission mixed concentration is calculated. That is, the road traffic carbon emission mixed concentration value is obtained.

In S211, hierarchical visualization processing is performed on the road traffic carbon emission mixed concentration value to obtain a road traffic carbon emission prediction map.

As shown in FIG. 4, road traffic carbon emission mapping and visualization are performed. Intensity level classification and map visualization are performed by using a grading and coloring tool based on the road traffic carbon emission mixed concentration value to obtain a road traffic carbon emission mapping result.

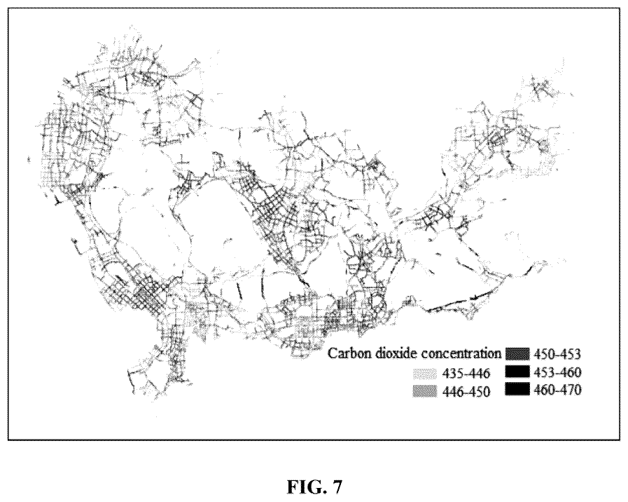

FIG. 7 shows a road traffic carbon emission prediction map. It is obvious that road traffic carbon emission aggregation regions exist in places of Longhua district, Baoan district, and surrounding areas of Huaqiangbei due to that daily life and social-economic activities are concentrated in these places and congestions often occur in these places, resulting in the road traffic carbon emission aggregation. In addition, maximum road traffic carbon emission concentrations, marked as a black linear grid, in large tunnels are accurately determined in the embodiment of the present disclosure. Due to a space shielding effect and a pipeline effect, carbon dioxide inside these tunnels cannot be diluted by surrounding air timely, causing microclimate changes inside the tunnels, and resulting in turbulence, heat islands, pollutant aggregation and other traffic risks.

In S212, a feature contribution degree of each of environment variables in an environment variable set for the carbon emission prediction model is calculated by using a SHAP analysis algorithm to obtain a variable feature data set. The environment variable set includes the environment variables affecting the road traffic carbon emission.

As shown in FIG. 4, environmental influence factors are identified. Influence factors of the carbon emission prediction model are analyzed by using an open-source module SHAP of Python, and s feature contribution degree of each of environment variables in the environment variable set is calculated to obtain the variable feature data set.

In S213, visualization processing is performed based on environment variables corresponding to the variable feature data sets to obtain a feature importance map.

The variable feature data sets are sorted based on feature importance to obtain the top 10 sorted variable feature data sets. Visualization processing is performed on 10 environment variables corresponding to the sorted variable feature data sets to obtain the feature importance graph.

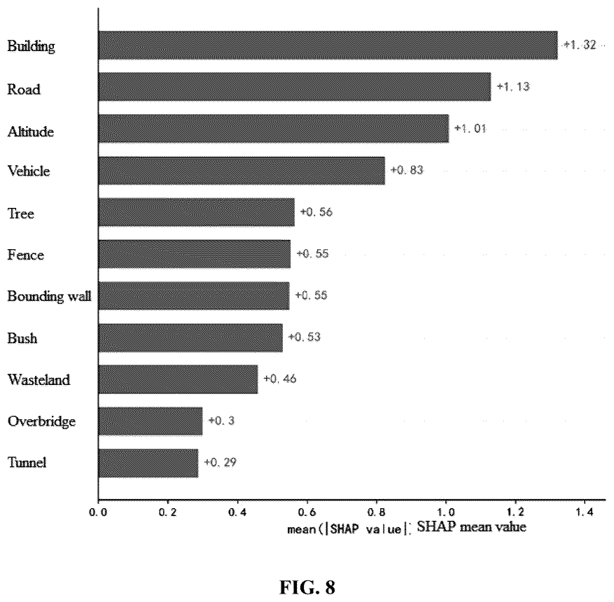

FIG. 8 shows a schematic diagram of feature importance. Buildings, roads, altitude and vehicles are key physical environment factors affecting carbon dioxide concentration, which is consistent with the results of other measurements previously performed in Shenzhen. In road space, buildings are the main source of carbon emissions, especially some residential buildings and industrial buildings directly emit carbon. A wider road carries a greater traffic flow, and more heavy vehicles indicate a higher road traffic carbon emission concentration. Since Shenzhen is a mountainous coastal city with significant terrain fluctuations, altitude is an important topographic factor affecting carbon emission concentration. Vehicles are the main source of road traffic carbon emission, and vehicle congestion and daily clustering affect road traffic carbon emission. The above factors are the most important spatial environmental variables resulting in urban road traffic carbon emissions.

Therefore, it can be seen that the machine learning simulation based on panoramic perception and road traffic carbon emissions may be used for identifying the influence factors of road traffic carbon emissions at the urban scale, which is crucial for traffic planning management and ecological environment monitoring.

With the method for predicting a road traffic carbon emission based on panoramic images according to the embodiments of the present disclosure, a navigation system synchronously monitoring panoramic images and carbon emissions is constructed, a training dataset is established based on the really measured street view panoramic images and carbon emission concentrations, regression training and interpretation are performed by using panoramic segmentation of the Transformer architecture, LightGBM, and TreeSHAP machine learning framework, a high-precision and high-resolution prediction simulation is performed on the local street view panorama data in Shenzhen, the simulated carbon dioxide emission intensity is graded and visualized, and the key environmental influence factors of road traffic carbon emissions are analyzed based on Shapley values, thereby improving the resolution of the constructed carbon emission prediction model and facilitating the understanding of the interactive relationship between street environments and carbon emission intensities.

Referring to FIG. 9, an apparatus 900 for predicting a road traffic carbon emission based on panoramic images is provided according to an embodiment of the present disclosure. The apparatus includes an acquiring unit 901, an analysis unit 902, and an obtaining unit 903.

The acquiring unit 901 is configured to acquire a historical street view image of an observation region from the Internet.

The analysis unit 902 is configured to perform feature analysis on the historical street view image to obtain a historical feature vector.

The obtaining unit 903 is configured to obtain a road traffic carbon emission predicted value based on the historical feature vector and a carbon emission prediction model. The carbon emission prediction model is an ensemble learning model obtained through training, and training samples for the carbon emission prediction model include multiple collected street view images and collected road traffic carbon emission concentration data corresponding to the multiple collected street view images.

In an embodiment, the apparatus 900 further includes a geographic mapping unit, a spatial aggregation unit, and a visualization unit.

The geographic mapping unit is configured to perform geographic mapping on the road traffic carbon emission predicted value based on coordinate data of the historical street view image to make coordinate data of the road traffic carbon emission predicted value to be consistent with the coordinate data of the historical street view image.

The spatial aggregation unit is configured to perform spatial aggregating on the road traffic carbon emission predicted value to obtain a road traffic carbon emission mixed concentration value.

The visualization unit is configured to perform hierarchical visualization processing on the road traffic carbon emission mixed concentration value to obtain a road traffic carbon emission prediction map.

In an embodiment, the apparatus 900 further includes a fusing unit and a training unit. In training the carbon emission prediction model, the acquiring unit 901 is further configured to obtain the multiple collected street view images and the multiple corresponding road traffic carbon emission concentration data from a spatiotemporal database, where the spatiotemporal database, with a timestamp string as a primary key, stores the multiple collected street view images and the multiple corresponding road traffic carbon emission concentration data; the analysis unit 902 is further configured to perform analysis on the multiple collected street view images to obtain multiple collected feature vectors, where each of the collected feature vectors includes a pixel semantic classification vector and a target recognition statistical vector; the fusing unit is configured to perform fusing and concatenating on the pixel semantic classification vector and the target recognition statistical vector corresponding to each of the collected feature vectors, and obtain multiple fused feature vectors; and the training unit is configured to train an initial model with the multiple fused feature vectors and the multiple collected road traffic carbon emission concentration data as the training samples to obtain the carbon emission prediction model.

In an embodiment, the apparatus 900 further includes a removing unit, a spatial registration unit, and a storage unit. In obtaining the spatiotemporal database, the obtaining unit 903 is further configured to obtain observation data and perform data cleaning on collected road traffic carbon emission concentration data in the observation data, where the observation data includes collected street view images and collected road traffic carbon emission concentration data of the observation region; the removing unit is configured to perform time-scale aggregation with a predetermined time interval to remove observation data staying at a same coordinate for more than a predetermined staying time period and observation data repeatedly observed; the spatial registration unit is configured to perform spatial registering on coordinates in filtered observation data based on a road network vector layer; and the storage unit is configured to store the filtered observation data in a structured database with the timestamp string as the unique primary key to obtain the spatiotemporal database.

In an embodiment, the apparatus 900 further includes a processing unit. In obtaining the observation data, the acquiring unit 901 is further configured to acquire vector road data of the observation area from the Internet; the obtaining unit 903 is further configured to obtain a navigation path based on the vector road data; the processing unit is configured to monitor road traffic carbon emission concentrations and capturing street view images based on the navigation path; and the obtaining unit 903 is further configured to export the monitored road traffic carbon emission concentrations to obtain the collected road traffic carbon emission concentration data, and store the captured street view images in an image format to obtain the collected street view images.

In an embodiment, the apparatus 900 further includes an analyzing unit, a sorting unit, and a visualization unit. The analyzing unit is configured to calculate, by using a SHAP analysis algorithm, a feature contribution degree of each of environment variables in an environment variable set for the carbon emission prediction model to obtain a variable feature data set, where the environment variable set includes the environment variables affecting the road traffic carbon emission. The sorting unit is configured to sort the environment variables in the variable feature data set based on feature importance to obtain a sorted variable feature data set with a predetermined number. The visualization unit is configured to perform visualization processing on environment variable corresponding to the sorted variable feature data set to obtain a feature importance map.

It should be noted that the specific implementation and the achieved effect of the apparatus 900 for predicting a road traffic carbon emission based on panoramic images may refer to the descriptions of the method shown in FIG. 1 or FIG. 2, and are not repeated herein.

An electronic device 10 is further provided according to an embodiment of the present disclosure. As shown in FIG. 10, the electronic device 10 includes a memory 11 and a processor 12. The memory 11 stores a computer program. The processor 12 is configured to execute the computer program to perform the method shown in FIG. 1 or FIG. 2.

A computer-readable storage medium is further provided according to an embodiment of the present disclosure. The computer-readable storage medium stores a computer program. The computer program is executed to perform the method shown in FIG. 1 or FIG. 2.

From the above embodiments, those skilled in the art can clearly understand that all or a part of steps of the method according to the above embodiments may be implemented through software and a general hardware platform. Based on such understanding, technical solutions of the present disclosure may be implemented as a software product. The computer software product may be stored in a storage medium, such as a read-only memory (ROM)/RAM, a magnetic disc or an optical disk, and the computer software product includes multiple instructions for enabling a computer device (which may be a personal computer, a server, a workstation, or a network communication device such as a router) to perform the method described in the embodiments or some of the embodiments of the present disclosure.

The embodiments in this specification are described in a progressive manner. Various embodiments may refer to each other for the same or similar parts, and each embodiment focuses on the difference from other embodiments. Especially, since the apparatus embodiments are similar to the method embodiments, the description of the apparatuses is simple. For relevant details, one may refer to the descriptions in the method embodiments. The apparatus embodiments described above are only illustrative. The modules described as separate components may be or may not be separated physically, and the components shown as modules may be or may not be physical modules, that is, the components may be arranged at the same position or may be distributed in multiple network units. Some or all modules may be selected according to actual requirements to implement the solutions in the embodiments. Those skilled in the art can understand and implement the solutions without any creative effort.

The foregoing descriptions are only exemplary embodiments of the present disclosure, and are not intended to limit the protection scope of the present disclosure.

1. A method for predicting a road traffic carbon emission based on panoramic images, comprising:
acquiring a historical street view image of an observation region from the Internet;
performing feature analysis on the historical street view image to obtain a historical feature vector; and
obtaining a road traffic carbon emission predicted value based on the historical feature vector and a carbon emission prediction model, wherein the carbon emission prediction model is an ensemble learning model obtained through training, and training samples for the carbon emission prediction model comprise a plurality of collected street view images and a plurality of corresponding road traffic carbon emission concentration data.

2. The method according to claim 1, further comprising:
performing geographic mapping on the road traffic carbon emission predicted value based on coordinate data of the historical street view image to make coordinate data of the road traffic carbon emission predicted value to be consistent with the coordinate data of the historical street view image;
performing spatial aggregating on the road traffic carbon emission predicted value to obtain a road traffic carbon emission mixed concentration value; and
performing hierarchical visualization processing on the road traffic carbon emission mixed concentration value to obtain a road traffic carbon emission prediction map.

3. The method according to claim 1, wherein the carbon emission prediction model is trained by:
obtaining the plurality of collected street view images and the plurality of corresponding road traffic carbon emission concentration data from a spatiotemporal database, wherein the spatiotemporal database, with a timestamp string as a primary key, stores the plurality of collected street view images and the plurality of corresponding road traffic carbon emission concentration data;
performing analysis on the plurality of collected street view images to obtain a plurality of collected feature vectors, wherein each of the collected feature vectors comprises a pixel semantic classification vector and a target recognition statistical vector;
performing fusing and concatenating on the pixel semantic classification vector and the target recognition statistical vector corresponding to each of the collected feature vectors, and obtaining a plurality of fused feature vectors; and
training an initial model with the plurality of fused feature vectors and the plurality of collected road traffic carbon emission concentration data as the training samples to obtain the carbon emission prediction model.

4. The method according to claim 3, wherein the spatiotemporal database is obtained by:
obtaining observation data, and performing data cleaning on collected road traffic carbon emission concentration data in the observation data, wherein the observation data comprises collected street view images and collected road traffic carbon emission concentration data of the observation region;
performing time-scale aggregation at a predetermined time interval to remove observation data staying at a same coordinate for more than a predetermined staying time period and observation data repeatedly observed;
performing spatial registering on coordinates in filtered observation data based on a road network vector layer; and
storing the filtered observation data in a structured database with the timestamp string as the unique primary key to obtain the spatiotemporal database.

5. The method according to claim 4, wherein the observation data is obtained by:
acquiring vector road data of the observation region from the Internet;
obtaining a navigation path based on the vector road data;
monitoring road traffic carbon emission concentrations and capturing street view images based on the navigation path; and
exporting the monitored road traffic carbon emission concentrations to obtain the collected road traffic carbon emission concentration data, and storing the captured street view images in an image format to obtain the collected street view images.

6. The method according to claim 1, further comprising:
calculating, by using a SHAP analysis algorithm, a feature contribution degree of each of environment variables in an environment variable set for the carbon emission prediction model to obtain a variable feature data set, wherein the environment variable set comprises the environment variables affecting the road traffic carbon emission;
sorting variable feature data sets based on feature importance to obtain a predetermined number of sorted variable feature data sets; and
performing visualization processing on environment variables corresponding to the sorted variable feature data sets to obtain a feature importance map.

7. An apparatus for predicting a road traffic carbon emission based on panoramic images, comprising:
an acquiring unit, configured to acquire a historical street view image of an observation region from the Internet;
an analysis unit, configured to perform feature analysis on the historical street view image to obtain a historical feature vector; and
an obtaining unit, configured to obtain a road traffic carbon emission predicted value based on the historical feature vector and a carbon emission prediction model, wherein the carbon emission prediction model is an ensemble learning model obtained through training, and training samples for the carbon emission prediction model comprise a plurality of collected street view images and a plurality of corresponding road traffic carbon emission concentration data.

8. The apparatus according to claim 7, further comprising:
a geographic mapping unit, configured to perform geographic mapping on the road traffic carbon emission predicted value based on coordinate data of the historical street view image to make coordinate data of the road traffic carbon emission predicted value to be consistent with the coordinate data of the historical street view image;
a spatial aggregation unit, configured to perform spatial aggregating on the road traffic carbon emission predicted value to obtain a road traffic carbon emission mixed concentration value; and
a visualization unit, configured to perform hierarchical visualization processing on the road traffic carbon emission mixed concentration value to obtain a road traffic carbon emission prediction map.

9. An electronic device, comprising:
a memory; and
a processor, wherein
the processor is configured to execute a program stored in the memory to perform the method according to claim 1.

10. A computer-readable storage medium, storing a computer program, wherein the computer program is executed to perform the method according to claim 1.
